(19) United States
(12) Patent Application Publication
(10) Pub. No.: US 2025/0384364 A1
(43) Pub. Date: Dec. 18, 2025

(54) Optimization of Production Planning

(71) Applicant: Siemens Aktiengesellschaft, München (DE)

(72) Inventors: Jan Christoph Wehrstedt, München (DE); Birgit Obst, München (DE); Annelie Sohr, München (DE); Wolfram Klein, Neubiberg (DE); Franz Georg Listl, Pettendorf (DE); Nils Weinert, München (DE); Roland Rosen, Seefeld (DE); Jan Fischer, München (DE)

(73) Assignee: Siemens Aktiengesellschaft, München (DE)

(21) Appl. No.: 18/877,172

(22) PCT Filed: Jun. 21, 2023
(86) PCT No.: PCT/EP2023/066806

§ 371 Date: Dec. 19, 2024

(30) Foreign Application Priority Data
Jun. 21, 2022 (EP) 22180141.8

(51) Int. Cl. G06Q 10/0631; G06Q 10/067; G06Q 50/04

(52) U.S. Cl. CPC G06Q 10/063112; G06Q 10/06316; G06Q 10/0674; G06Q 50/04

(57) ABSTRACT

Various embodiments of the teachings herein include an apparatus for optimizing production planning for production of a product, wherein workers are assigned to operate machines for producing the product. An example includes: an interface to import planning data for the production and competency information regarding machine operation and availability information of the workers; a first optimization module to determine an optimized percentage assignment of the workers to the respective machines for a defined time period based on the planning data, the competency information, and the availability information; a second optimization module to determine optimized production planning data, wherein an optimized time sequence of respective production steps is determined based on the planning data with respect to the workers and machines according to the percentage assignment and the number of workers needed for a production step; and an output module to distribute the optimized production planning data.

### CROSS-REFERENCE TO RELATED APPLICATIONS

This application is a U.S. National Stage Application of International Application No. PCT/EP2023/066806 filed Jun. 21, 2023, which designates the United States of America, and claims priority to EP Application No. 22180141.8 filed Jun. 21, 2022, the contents of which are hereby incorporated by reference in their entirety.

### TECHNICAL FIELD

The present disclosure relates to production planning. Some embodiments of the teachings herein include production of at least one product, wherein workers are assigned to operate machines for producing the at least one product.

### BACKGROUND

In industrial production, personnel are normally allocated in advance to various machines, for instance for the purpose of operation or supervision. In addition, it is established which production steps are made on a particular machine in a given time period. This production planning is normally carried out a priori or offline. For the time period under consideration, workers are assigned to machines or work areas on a fixed basis. Such planning and deployment are often not efficient, which can impair a production flow, for example.

### SUMMARY

Teachings of the present disclosure may be used to optimize production planning for production of a product or a plurality of products. For example, some embodiments of the teachings herein include an apparatus (100) for optimizing production planning for production of at least one product, wherein workers (W) are assigned to operate machines for producing the at least one product, wherein the apparatus comprises: an interface (101), which is configured to import planning data (PD) for the production, and also competency information (CI) regarding machine operation and availability information (AI) on the workers (W); a first optimization module (102), which is configured to determine an optimized percentage assignment (PA) of the workers to the respective machines for a defined time period according to the planning data, the competency information and the availability information; a second optimization module (103), which is configured to determine optimized production planning data (PD_opt), wherein an optimized time sequence of respective production steps is determined in accordance with the planning data (PD) with respect to the workers (W) and machines according to the percentage assignment (PA) and according to the number of workers needed for a production step; and an output module (104), which is configured to output the optimized production planning data (PD_opt) for producing the at least one product in accordance with the optimized production planning data.

In some embodiments, the first optimization module (102) determines the optimized assignment of the workers to the respective machines by means of a mixed integer optimization problem.

In some embodiments, the first optimization module (102) is configured to take into account at least one of the following boundary conditions in determining the optimized assignment of the workers to the respective machines: minimizing a change in workstation by a worker; even utilization of a worker; and/or compliance with machine-specific criteria.

In some embodiments, the second optimization module (103) is configured to take into account at least one of the following boundary conditions in determining the optimized production planning data: compliance with a defined sequence of the production steps; taking into account the bill of materials and/or bill of process; compliance with a completion date; a defined capacity of a machine; and/or minimizing retooling times.

In some embodiments, the second optimization module (103) is configured to determine, in the event that the production deviates in time from the optimized production planning data, re-optimized production planning data according to the optimized percentage assignment.

In some embodiments, the first optimization module (102) and/or the second optimization module (103) are configured to re-execute the associated optimization on the basis of a current production status.

In some embodiments, the apparatus additionally comprises a simulation module (105), wherein the simulation module is configured to perform a computer-aided material-flow simulation of the production according to the optimized production planning data, and to output simulation data (SIM).

In some embodiments, the simulation module (105) is configured to take into account transport times between machines.

In some embodiments, the apparatus additionally comprises a validation module (106), which is configured to validate the optimized production planning data on the basis of the simulation data (SIM).

In some embodiments, the apparatus additionally comprises a prediction module (107), which is configured to predict production-relevant data (PROD) on the basis of the simulation data (SIM).

As another example, some embodiments include a computer-implemented method for optimizing production planning for production of at least one product, wherein workers are assigned to operate machines for producing the at least one product, comprising: importing (S1) planning data for the production, competency information regarding machine operation and availability information on the workers; determining (S2) an optimized percentage assignment of the workers to the respective machines for a defined time period according to the planning data, the competency information and the availability information; determining (S3) optimized production planning data, wherein an optimized time sequence of respective production steps is determined in accordance with the planning data with respect to the workers and machines according to the percentage assignment and according to the number of workers needed for a production step; and outputting (S4) the optimized production planning data for producing the at least one product in accordance with the optimized production planning data.

As another example, some embodiments include a computer program product which can be loaded directly into a programmable computer, comprising program code parts which are suitable for carrying out one or more of the methods described herein.

### BRIEF DESCRIPTION OF THE DRAWINGS

Exemplary embodiments of the teachings herein are illustrated by way of example in the drawings and are explained in more detail with reference to the following description. In the figures:

FIG. 1: shows an exemplary embodiment of an apparatus incorporating teachings of the present disclosure for optimizing production planning; and

FIG. 2: shows an exemplary embodiment of a method incorporating teachings of the present disclosure for optimizing production planning.

Parts corresponding to one another are provided with the same reference signs in all of the figures.

### DETAILED DESCRIPTION

Some examples of the teachings herein include an apparatus for optimizing production planning for production of at least one product, wherein workers are assigned to operate machines for producing the at least one product. The apparatus may include:
a) an interface, which is configured to import planning data for the production, and also competency information regarding machine operation and availability information on the workers;
b) a first optimization module, which is configured to determine an optimized percentage assignment of the workers to the respective machines for a defined time period according to the planning data, the competency information and the availability information;
c) a second optimization module, which is configured to determine optimized production planning data, wherein an optimized time sequence of respective production steps is determined in accordance with the planning data with respect to the workers and machines according to the percentage assignment and according to the number of workers needed for a production step; and
d) an output module, which is configured to output the optimized production planning data for producing the at least one product in accordance with the optimized production planning data.

The apparatus described herein may be suitable for optimizing the production planning for producing a large quantity of a product, which product consists of a plurality of components, for example.

The production of the individual components is performed, for example, in defined production steps, each on different machines, which are each operated or supervised by a worker. Planning data for the production can specify, for instance on the basis of capacities of the available or required machines, what volume can be produced in a defined time period. The planning data thus preferably comprises a capacity assessment.

Competency information regarding machine operation by the workers relates to, for example, the training or professional qualifications of the workers that are relevant to operating a machine. In particular, competency information for a worker can comprise a qualifications profile. Availability information for the workers comprises information about work shifts and personal working times. The availability information is preferably provided at the shift level.

The planning data, the competency information, and the availability information can be imported in particular as a dataset or as individual datasets and provided for the further production optimization.

No fixed assignment is made of workers to workstations or machines, but instead the workers and the production processes are assigned at the same time. This is done by using two optimization steps to optimize the production fine-planning. This may lead to an improvement in the production flow, additionally reduces the complexity and allows the production planning data to be recalculated adaptively.

In some embodiments, the first optimization module can determine the optimized assignment of the workers to the respective machines by means of a mixed integer optimization problem. In particular, a MILP optimization problem or a MINLP optimization problem is formulated with the objective of maximum processing for a defined time period under consideration. In particular, first a simple comparison can be made of a qualifications profile of a worker with machine requirements.

In some embodiments, the first optimization module can be configured to take into account at least one of the following boundary conditions in determining the optimized assignment of the workers to the respective machines:
minimizing a change in workstation by a worker;
even utilization of a worker; and/or
compliance with machine-specific criteria such as avoiding cold-starts, for instance.

In some embodiments, the second optimization module can be configured to take into account at least one of the following boundary conditions in determining the optimized production planning data:
compliance with a defined sequence of the production steps;
taking into account the bill of materials and/or bill of process;
compliance with a completion date;
a defined capacity of a machine; and/or
minimizing retooling times.

In some embodiments, the second optimization module can be configured to determine, in the event that the production deviates in time from the optimized production planning data, re-optimized production planning data according to the optimized percentage assignment. It is thereby possible to find a new solution to the second optimization problem and determine updated production planning data.

In some embodiments, the first optimization module and/or the second optimization module can be configured to re-execute the associated optimization on the basis of a current production status. In particular, this can be carried out for productions steps that are still outstanding.

In some embodiments, the apparatus can additionally comprise a simulation module, wherein the simulation module is configured to perform a computer-aided material-flow simulation of the production according to the optimized production planning data, and to output simulation data.

In some embodiments, the simulation module can be configured to take into account transport times between machines.

In some embodiments, the apparatus can comprise a validation module, which is configured to validate the optimized production planning data on the basis of the simulation data. Thus the optimization may be carried out separately from a material-flow simulation. For example, the simulation allows a check of the production planning data. In addition, the simulation allows a fine-adjustment to the production planning data, because in particular transport times can also be taken into account.

In some embodiments, the apparatus can additionally comprise a prediction module, which is configured to predict production-relevant data on the basis of the simulation data. For example, it is possible to calculate material consumption or energy consumption by means of the simulation.

Some embodiments include a computer-implemented method for optimizing production planning for production of at least one product, wherein workers are assigned to operate machines for producing the at least one product, comprising:
importing planning data for the production, competency information regarding machine operation and availability information on the workers;
determining an optimized percentage assignment of the workers to the respective machines for a defined time period according to the planning data, the competency information and the availability information;
determining optimized production planning data, wherein an optimized time sequence of respective production steps is determined in accordance with planning data with respect to the workers and machines according to the percentage assignment and according to the number of workers needed for a production step; and
outputting the optimized production planning data for producing the at least one product in accordance with the optimized production planning data.

Some embodiments include a computer program product which can be loaded directly into a programmable computer, comprising program code parts which, when the program is executed by a computer, cause the computer to carry out one or more of the methods described herein. A computer program product may be provided or supplied for example on a storage medium such as for example a memory card, USB stick, CD-ROM, DCD, a non-transitory storage medium or else may be provided or supplied in the form of a downloadable file from a server in a network.

In particular, the exemplary embodiments that follow merely show illustrative realization possibilities, how in particular such realizations of the teaching according to the invention could be manifested, since it is impossible and also not helpful or necessary for the understanding of the invention to name all these realization possibilities.

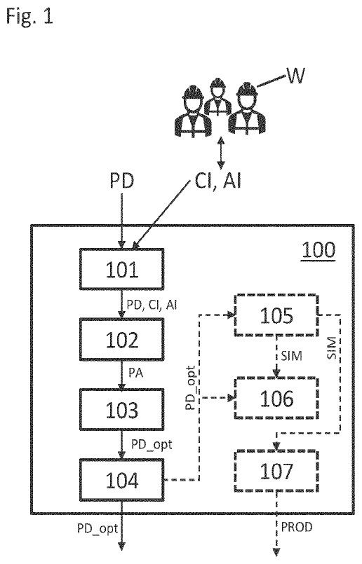

FIG. 1 shows an apparatus 100 incorporating teachings of the present disclosure for optimizing production planning for production of at least one product, wherein workers W are assigned to operate machines for producing the at least one product. Machines are each configured, for example, to produce at least one part of the product. The product can consist of a multiplicity of product components, for example, which are produced, machined and/or joined in individual production steps. Individual production steps can be carried out on respective machines. The product can be produced in a large quantity, for example. For the production are needed, for example, different machines, each operated by workers. One worker can also operate a plurality of machines. The apparatus can be used to provide optimized production planning, which assigns individual production steps and workers to machines in an optimized manner in order to achieve efficient production.

The apparatus 100 comprises an interface 101, a first optimization module 102, a second optimization module 103 and an output module 104. The apparatus 100 can optionally comprise also a simulation module 105, a validation module 106 and/or a prediction module 107. In addition, the apparatus 100 can comprise at least one processor. The apparatus 100 can comprise in particular software components and hardware components; for example, modules of the apparatus can be embodied as software components. It may be an assistance system, for example.

The interface 101 is configured to import planning data PD for the production. The planning data PD specifies, for example, what quantity of the product is meant to be produced in a defined time period by defined machines. The planning data can also be imported from online systems (SAP, MES). In addition, competency information CI regarding machine operation and availability information AI on the workers is imported via the interface 101. In some embodiments, competency information and availability information is present for each worker. The planning data PD, the competency information CI and the availability information AI are transferred to the first optimization module 102.

The first optimization module 102 is configured to determine an optimized percentage assignment PA of the workers W to the respective machines for a defined time period according to the planning data PD, the competency information CI and the availability information. This is preferably solved by means of a mixed integer optimization problem. The optimization module 102 may take into account here the following boundary conditions in the optimization:
minimizing a change in workstation by a worker;
even utilization of one worker or all workers; and/or
compliance with machine-specific criteria such as avoiding cold-starts or downtimes, for instance.

The optimized percentage assignment PA of the workers to the respective machines is transferred to the second optimization module 103 as an input.

The second optimization module 103 is configured to determine optimized production planning data PD_opt. In this process, an optimized time sequence of respective production steps is calculated in accordance with the planning data PD with respect to the workers W and machines according to the percentage assignment PA and according to the number of workers W needed for a production step. A time allocation and/or sequencing (scheduling) is defined as a result. The objective is time optimization.

The second optimization module 103 may take into account the following boundary conditions:
compliance with a defined sequence of the production steps;
taking into account the bill of materials and/or bill of process;
compliance with a completion date;
a defined capacity of a machine; and/or
minimizing retooling times.

The optimized production planning data PD_opt can then be output in order to carry out the production of the at least one product in accordance with the optimized production planning data.

In the event that the production deviates from the optimized production planning data, the second optimization module 103 can determine new optimized production planning data according to the optimized percentage assignment PA.

In addition, the first optimization module 102 and/or the second optimization module 103 can re-execute the associated optimization on the basis of a current production status for the production steps that are still open.

The optimized production planning data PD_opt can also be passed to the simulation module 105 and to the validation module 106.

The simulation module 105 is configured to perform a computer-aided material-flow simulation of the production according to the optimized production planning data PA. This can take into account in particular transport times between machines. The simulation module 105 provides relevant simulation data SIM.

The simulation data SIM can be transferred to the validation module 106. The validation module 106 is configured to validate the optimized production planning data PD_opt on the basis of the simulation data SIM. This allows also a further refinement to the planning.

In addition, the simulation data SIM can be transferred to the prediction module 107. The prediction module 107 is configured to predict production-relevant data PROD on the basis of the simulation data SIM. For example, machine running times, material consumption or energy consumption can be determined on the basis of the simulation data.

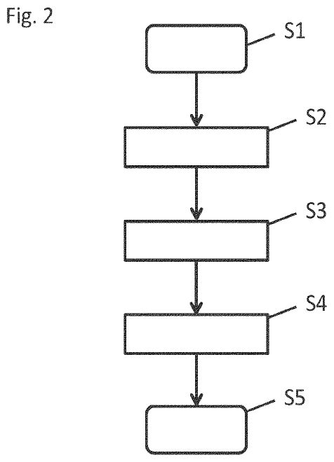

FIG. 2 shows an exemplary embodiment of a computer-implemented method incorporating teachings of the present disclosure for optimizing production planning for production of at least one product, wherein workers W are assigned to operate machines for producing the at least one product. In particular, the method can be performed by an apparatus as described by way of example with reference to FIG. 1. The method shown comprises:

In the first step S1 are imported planning data for the production, competency information regarding machine operation and availability information on the workers.

In the next step S2, an optimized percentage assignment of the workers to the respective machines for a defined time period is determined according to the planning data, the competency information and the availability information.

In the next step S3 is determined optimized production planning data, wherein an optimized time sequence of respective production steps is determined in accordance with the planning data with respect to the workers and machines according to the percentage assignment and according to the number of workers needed for a production step.

In the next step S4, the optimized production planning data is output. For example, the optimized production planning data can be provided to the relevant workers. For example, the optimized production planning data can be provided personally to a particular worker. It can be provided on smart devices, for example. It is also possible that a summary of the optimized production planning data is provided for a shift manager.

Then, S5, the product can be produced in accordance with the optimized production planning data.

All of the features described and/or shown may advantageously be combined with one another within the scope of the disclosure. The teachings are not restricted to the described exemplary embodiments.

What is claimed is:

1. An apparatus for optimizing production planning for production of a product, wherein workers are assigned to operate machines for producing the product, the apparatus comprising:
an interface to import planning data for the production and competency information regarding machine operation and availability information of the workers;
a first optimization module to determine an optimized percentage assignment of the workers to the respective machines for a defined time period based on the planning data, the competency information, and the availability information;
a second optimization module to determine optimized production planning data wherein an optimized time sequence of respective production steps is determined based on the planning data with respect to the workers and machines according to the percentage assignment and the number of workers needed for a production step; and
an output module to distribute the optimized production planning data.

2. The apparatus as claimed in claim 1, wherein the first optimization module determines the optimized assignment of the workers to the respective machines using a mixed integer optimization problem.

3. The apparatus as claimed in claim 1, wherein the first optimization module takes into account at least one of the following boundary conditions in determining the optimized assignment of the workers to the respective machines:
minimizing a change in workstation by a worker;
even utilization of a worker; and/or
compliance with machine-specific criteria.

4. The apparatus as claimed in claim 1, wherein the second optimization module takes into account at least one of the following boundary conditions in determining the optimized production planning data:
compliance with a defined sequence of the production steps;
taking into account the bill of materials and/or bill of process;
compliance with a completion date;
a defined capacity of a machine; and/or
minimizing retooling times.

5. The apparatus as claimed in claim 1, wherein the second optimization module determines, in the event that the production deviates in time from the optimized production planning data, re-optimized production planning data according to the optimized percentage assignment.

6. The apparatus as claimed in claim 1, wherein at least one of the first optimization module and the second optimization module is configured to re-execute the associated optimization on the basis of a current production status.

7. The apparatus as claimed in claim 1, further comprising a simulation module to perform a computer-aided material-flow simulation of the production according to the optimized production planning data, and generate simulation data.

8. The apparatus as claimed in claim 7, wherein the simulation module accounts for transport times between machines.

9. The apparatus as claimed in claim 7, further comprising a validation module to validate the optimized production planning data on the basis of the simulation data.

10. The apparatus as claimed in claim 7, further comprising a prediction module to predict production-relevant data on the basis of the simulation data.

11. A method for optimizing production planning for production of a product, wherein workers are assigned to operate machines for producing the product, the method comprising:
importing planning data for the production, competency information regarding machine operation, and availability information of the workers;
determining an optimized percentage assignment of the workers to the respective machines for a defined time period according to the planning data, the competency information, and the availability information;
determining optimized production planning data, wherein an optimized time sequence of respective production steps is determined in accordance with the planning data with respect to the workers and machines according to the percentage assignment and according to the number of workers needed for a production step; and
distributing the optimized production planning data for producing the product in accordance with the optimized production planning data.

12. (canceled)
